(19) United States
(12) Patent Application Publication
(10) Pub. No.: US 2015/0307672 A1
(43) Pub. Date: Oct. 29, 2015

(54) FILM IN WHICH HAZE IS IMPROVED

(71) Applicant: SAMSUNG FINE CHEMICALS CO., LTD., Nam-gu, Ulsan (KR)

(72) Inventors: Jin Ryul SON, Incheon (KR); Kil Seuk BYUN, Yongin-si (KR)

(21) Appl. No.: 14/443,453

(22) PCT Filed: Jul. 16, 2013
(86) PCT No.: PCT/KR2013/006339

§ 371 Date: May 18, 2015

(30) Foreign Application Priority Data
Dec. 5, 2012 (KR) 10-2012-0140550

(51) Int. Cl. C08J 5/18

(52) U.S. Cl. CPC C08J 5/18; C08J 2301/26; C08J 2305/00

(57) ABSTRACT

Provided is a film. The film includes water-soluble cellulose ether, about 0.5 parts by weight to about 1.5 parts by weight of a gelation agent based on 100 parts by weight of the water-soluble cellulose ether, and 0 parts by weight to about 0.3 parts by weight of a gelation aid based on 100 parts by weight of the water-soluble cellulose ether, wherein light transmittance is 80% or greater.

### TECHNICAL FIELD

The present invention relates to a film, and more particularly, to a film having improved haze.

### BACKGROUND ART

In general, hard capsules are prepared by using gelatin derived from bovine animal or swine.

Gelatin-containing aqueous compositions are prepared in a relatively short period of time due to the possibility of the direct dissolution of gelatin in high-temperature water (for example, 60° C.), and when a mold pin is immersed therein and then taken therefrom to dry the gelatin-containing aqueous compositions coated on the mold pin, the drying time is short, the obtained hard capsule may have excellent elasticity, glossiness, and disintegrability, and the production yield of the hard capsule is very high. However, a concern on the mad cow disease has limited the use of gelatin capsules., and accordingly, capsules prepared by using a plant-based cellulose ether, instead of the gelatin, are getting much attention.

However, although cellulose ether dissolves in room temperature (25° C.) water, as soon as the cellulose ether is added to water, most of the cellulose ether aggregates to form an aggregate, thus requiring a long time for complete dissolution. To prevent this problem, when an aqueous composition for preparing a film is prepared, the cellulose ether is added to high temperature (for example, 80° C. or higher) water to prevent the aggregation and then dispersed well to prepare a dispersion. Then, the dispersion is naturally cooled down to a first temperature (for example, about 40° C. to about 50° C.) to dissolve the dispersed cellulose ether in water. Thereafter, the resultant is heated to a second temperature (for example, about 55° C. to about 65° C.), and then a gelation agent and optionally a gelation aid are added to the resultant. In this regard, the heating of the resultant to the second temperature is performed to prevent solidification of the gelation agent and the gelation aid. However, cellulose ether may not be completely dissolved in water at the second temperature, and thus an aqueous composition and a final hard capsule, including the cellulose ether, may have the following disadvantages:

(1) the aqueous composition may have a varying viscosity according to location and may also undergo a layer-separation during a long-term storage;

(2) a degree of mixing of a cellulose ether and a gelation agent (and optionally, a gelation aid) in the aqueous composition may decrease, thereby requiring more gelation agent (and optionally, a gelation aid) to be added thereto. However, due to the addition, a haze phenomenon occurs on a capsule surface;

(3) the aqueous composition may have a low filtering efficiency in a subsequent filtering process for removing foreign materials (for example, fiber) therefrom;

(4) even after the filtering process, foreign materials may remain in the aqueous composition to deteriorate the performance of a capsulation agent and/or a capsulation aid, leading to a decrease in capsule moldability or formability;

(5) when a drying process is performed to evaporate water in the aqueous composition coated on a substrate (for example, a mold pin) in a capsule molding process, a drying rate of the aqueous composition is low;

(6) the preparation time and drying time of the aqueous composition are long, and thus, the production yield of a hard capsule is low; and

(7) foreign materials remaining in the aqueous composition are included in a hard capsule, which is a final product, and due to the included foreign materials, the quality (elasticity, glossiness, disintegrability, or the like) of the hard capsule decreases, and it is difficult to keep the quality of a hard capsule constant for all production lots.

### DETAILED DESCRIPTION OF THE INVENTIVE CONCEPT

### Technical Problem

The present invention provides a film having improved haze.

### Technical Solution

According to an aspect of the present invention, there is provided a film including a water-soluble cellulose ether; about 0.5 parts by weight to about 1.5 parts by weight of a gelation agent based on 100 parts by weight of the water-soluble cellulose ether; and 0 parts by weight to about 0.3 parts by weight of a gelation aid based on 100 parts by weight of the water-soluble cellulose ether, wherein light transmittance is 80% or greater.

The water-soluble cellulose ether may include hydroxypropyl methylcellulose (HPMC), hydroxyethyl methylcellulose (HEMC), methylcellulose (MC), or a mixture of two or more of these.

The gelation agent may include Carrageenan, Gellan gum, Xanthan gum, Pectin, or a mixture of two or more of these.

The gelation aid may include potassium chloride, potassium acetate, calcium chloride, or a mixture of two or more of these.

The film may further include 0 parts by weight to about 5.0 parts by weight of other additives based on 100 parts by weight of the water-soluble cellulose ether.

The other additives may include a plasticizer, an emulsifier, or a mixture of two or more of these.

The film may be a hard capsule, a flat film, a film for food, a medicinal film, or an industrial film.

### Advantageous Effects

A film according to an embodiment of the present invention has excellent tensile strength and hardness despite including a small amount of a gelation agent (and optionally a gelation aid), and has a low haze to have excellent light transmittance.

### BEST MODE

Hereinafter, a film according to an embodiment of the present invention is described in detail.

A film according to an embodiment of the present invention includes a water-soluble cellulose ether, about 0.5 parts by weight to about 1.5 parts by weight of a gelation agent based on 100 parts by weight of the water-soluble cellulose ether, about 0 parts by weight to about 0.3 parts by weight of a gelation aid based on 100 parts by weight of the water-soluble ether, and light transmittance of the film is 80% or greater (for example, 90% or greater). As used herein, the term “light transmittance” refers to light transmittance measured by irradiating light having a wavelength of 420 nm to a film using a UV spectrophotometer.

When the amount of the gelation agent is less than 0.5 parts by weight based on 100 parts by weight of the water-soluble cellulose ether, film moldability decreases and when the amount exceeds 1.5 parts by weight, not only does manufacturing cost of the film increase, but also a film having a low elongation at break, high brittleness, and an nonuniform film thickness is obtained.

When the amount of the gelation aid exceeds 0.3 parts by weight based on 100 parts by weight of the water-soluble cellulose ether, haze is high and thus, a film having low light transmittance is obtained.

The water-soluble cellulose ether is a major component of the film. The water-soluble cellulose ether is derived from plant-based cellulose, and is advantageous for being harmless to the human body. The term “cellulose ether” as used herein refers to a cellulose derivative prepared by etherifying a hydroxy group of cellulose by using an etherifying agent.

The water-soluble cellulose ether may include hydroxypropyl methylcellulose (HPMC), hydroxyethyl methylcellulose (HEMC), methylcellulose (MC), or a mixture of two or more of these.

The gelation agent performs a role of gelling an aqueous composition for preparing a film, which is described below.

The gelation agent may include a water-soluble gum.

The water-soluble gum may include Carrageenan, Gellan gum, Xanthan gum, Pectin, or a mixture of two or more of these.

The gelation aid supplements the gellability of the gelation agent to perform the role of improving film moldability of the aqueous composition for preparing a film.

The gelation aid may include potassium chloride, potassium acetate, calcium chloride, or a mixture of two or more of these.

The film may further include 0 parts by weight to about 5.0 parts by weight of other additives based on 100 parts by weight of the water-soluble cellulose ether.

The other additives may include a plasticizer, an emulsifier, or a mixture of two or more of these.

The plasticizer performs a role of improving film strength of the film.

The plasticizer may include glycerol, sorbitol, propylene glycol, polyethylene glycol, or a mixture of two or more of these.

The amount of the plasticizer may be about 0 wt % to about 5.0 wt % of the aqueous composition for preparing a film. When the amount of the plasticizer is within this range, a film having high elongation at break and transparency (hence, low haze) may be obtained.

The emulsifier performs a role of improving film moldability of the aqueous composition for preparing a film.

The emulsifier may include sodium lauryl sulfate (SLS), sucrose esters of fatty acids, or a mixture of these.

The amount of the emulsifier may be about 0 wt % to about 1.0 wt % of the aqueous composition for preparing a film. When the amount of the emulsifier is within this range, a film having high quality and harmless to human body may be obtained.

When the amount of the other additives is within the range above (0 parts by weight to about 5 parts by weight), a film having excellent transparency, quality and safety in human body may be obtained.

The film may be a hard capsule, a flat film, a film for food, a medicinal film, or an industrial film. The hard capsule may be gastric juice soluble.

Hereinafter, a method of preparing the film is described in detail.

(Preparation of Aqueous Composition for Film)

The aqueous composition for preparing a film includes water, alcohol, and water-soluble cellulose ether, and is prepared via a process for preparing a cellulose ether solution, which is maintained at a first temperature (about 40° C. to about 70° C.) that is higher than an atmospheric temperature (about 0° C. to about 39° C.). In detail, the aqueous composition for preparing a film may be prepared by mixing water and alcohol to prepare an aqueous alcohol solution (S1), heating the aqueous alcohol solution (S2), dissolving water-soluble cellulose ether in the heated aqueous alcohol solution to prepare a cellulose ether solution (S3), aging the cellulose ether solution (S4), and adding a gelation agent to the resultant (S5).

In the process (S2), the heating of the aqueous alcohol solution may be performed from room temperature (about 20° C. to about 30° C.) to a temperature of about 40° C. to about 70° C. The process (S2) is performed to allow the water-soluble cellulose ether to be dispersed well in the aqueous alcohol solution in the process (S3) so that the water-soluble cellulose ether is easily dissolved without aggregation. When the heating temperature is within this range, the gelation agent (and optionally, the gelation aid) may have high film moldability without solidification, and an aqueous composition for preparing a film that minimizes increases in energy costs due to inevitable heating may be obtained.

The process (S3) may be performed by slowly adding the water-soluble cellulose ether to the heated aqueous alcohol solution while stirring (for example, at 300 rpm).

However, the present invention is not limited thereto. For example, instead of the processes (S1 to S3), water-soluble cellulose ether may be dissolved in water (or alcohol) to prepare a first cellulose ether solution, and then alcohol (or water) may be added to the cellulose ether solution to prepare a second cellulose ether solution. Also, in this case, heated water and/or heated alcohol may be used in the preparation of the cellulose ether solution, or water-soluble cellulose ether may be dissolved in water (or alcohol) to prepare a first cellulose ether solution, and then the first cellulose ether solution may be heated and alcohol (or water) may be added thereto to prepare a second cellulose ether solution.

The aging process (S4) of the cellulose ether solution may be performed at a temperature of 40 to 70° C. for 2 to 12 hours. When the aging process (S4) is performed for this time range (hence, aging time), bubbles may be sufficiently removed from the resultant and a composition of the resultant may be uniform.

In the process (S4), a gelation aid and/or other additives (e.g., plasticizer, emulsifier, and the like)other than the gelation agent, may be further added to the resultant.

At least one process of the processes (S1 to S5) above may be performed while stirring.

The process (S5) may be additionally followed by removing bubbles from the aqueous composition for preparing a film. This process (S5) may be performed by stirring.

The aqueous composition for preparing a film prepared by the method above includes water-soluble cellulose ether, a gelation agent, alcohol, and water, wherein an amount of the gelation agent may be about 0.5 parts by weight to about 1.5 parts by weight based on 100 parts by weight of the water-soluble cellulose ether. When the amount of the gelation agent is less than 0.5 parts by weight based on 100 parts by weight of the water-soluble cellulose ether, the aqueous composition for preparing a film is not sufficiently gelled when being heated, thereby decreasing film moldability, and when the amount exceeds 1.5 parts by weight, not only does manufacturing cost of the aqueous composition for preparing a film increase, but also viscosity and gellability of the aqueous composition for preparing a film increase excessively, thus forming a film having a low elongation at break, high brittleness, and a nonuniform thickness due to a decrease in flowability of the aqueous composition for preparing a film in a film molding process.

Also, the aqueous composition for preparing a film may not include the gelation aid or may further include 0.3 parts by weight or less of the gelation aid based on 100 parts by weight of the water-soluble cellulose ether.

The aqueous composition for preparing a film may include about 10 wt % to about 25 wt % of the water-soluble cellulose ether.

When the amount of the water-soluble cellulose ether in the aqueous composition for preparing a film is within the range above (about 10 wt % to about 25 wt %), a suitable viscosity may be obtained such that bubbles are easily removed and a film having a suitable thickness may be obtained.

The aqueous composition for preparing a film may further include 0 parts by weight to about 5.0 parts by weight of other additives based on 100 parts by weight of the water-soluble cellulose ether.

The alcohol may help the water-soluble cellulose ether to be liquefied (i.e., dissolved) in the aqueous composition for preparing a film. This process is described in more detail as follows: when the water-soluble cellulose ether is added to room temperature (about 20° C. to about 30° C.) water, a part of the water-soluble cellulose ether that directly contacts water dissolves but other parts of the water-soluble cellulose ether that do not directly contact water aggregate to form a lump, and when the water-soluble cellulose ether is added to high temperature (about 40° C. to about 70° C.) water, even the part of the water-soluble cellulose ether that directly contacts water does not dissolve well. However, the alcohol is mixed with water to form an aqueous alcohol solution, and the water-soluble cellulose ether dissolves well not only in a room temperature (about 20° C. to about 30° C.) aqueous alcohol solution but also in a high temperature (about 40° C. to about 70° C.) aqueous alcohol solution.

The alcohol may include ethanol, methanol, isopropanol, butanol, or a mixture of two or more of these.

The aqueous composition for preparing a film may include about 5 wt % to about 30 wt % of the alcohol.

When the amount of the alcohol is within this range (about 5 wt % to about 30 wt %), solubility of the cellulose ether increases and an evaporation rate of the alcohol becomes suitable for a film preparation, and thus a smooth film without wrinkles may be obtained.

The functions, types, and the amounts of the water-soluble cellulose ether, the gelation agent, the gelation aid, the plasticizer, and the emulsifier are as described above, and thus explanations thereof will be omitted herein.

When the aqueous composition for preparing a film is heated to a film molding temperature (about 40° C. to about 70° C.), the water-soluble cellulose ether may be completely dissolved. Due to the complete dissolution of the water-soluble cellulose ether, the aqueous composition for preparing a film may have the following advantages: a shorter preparation time; higher homogeneity, uniform viscosity, and no layer-separation even during a period of long-term storage; uniform viscosity for all production lots; higher film moldability due to the absence of indissoluble materials (for example, cellulose ether) that suppress the performance of a gelation agent (and optionally, a gelation aid); reduction of the amount of a gelation agent (and optionally, a gelation aid) added due to a high degree of mixing of cellulose ether, the gelation agent, and the gelation aid; a high filtering efficiency in a subsequent filtering process for removing foreign materials from the aqueous composition for preparing a film; a higher drying rate, when a drying process is performed, due to a solvent component (e.g., alcohol) of the aqueous composition coated on a substrate (e.g., mold pin) in a film molding process; and a higher production yield of a film due to a shorter preparation time and drying time of the aqueous composition for preparing a film.

Also, the aqueous composition for preparing a film includes a small amount of expensive gelation agent and optionally includes a small amount of cheap gelation aid that may supplement the gellability of the gelation agent such that the aqueous composition for preparing a film not only has a low manufacturing cost, high homogeneity or uniformity, and gel strength, but may also form a film having a low haze.

(Preparation of Film)

The aqueous composition for preparing a film is coated on a substrate (a mold pin, a glass substrate, or the like) and then dried to prepare a film. For example, when the film is a hard capsule, the film may be manufactured by immersing a room temperature (about 20° C. to about 30° C.) mold pin in an aqueous composition for preparing a film heated to a high temperature (about 40° C. to about 70° C.), and taking out the mold pin from the aqueous composition to dry the mold pin.

The film is of high quality (elasticity, glossiness, disintegrability, and the like) due to the absence of a foreign material, such as fiber, in the aqueous composition for preparing a film, and the quality may be kept constant for all production lots.

Hereinafter, the present invention is described in greater detail with reference to Examples, but the present invention is not limited to the Examples.

### MODE OF THE INVENTIVE CONCEPT

### Example

### Examples 1 to 4, and Comparative Examples 1 and 2

(Preparation of Aqueous Composition for Preparing a Film)

Ethanol was mixed with water (purified water) at ratios shown in Table 1 below to prepare aqueous ethanol solutions. Thereafter, each of the aqueous ethanol solutions was heated to a temperature shown in Table 1 below, and then hydroxypropyl methylcellulose (HPMC) (available from Samsung Fine Chemicals Co., Ltd., AW4) was added in a ratio shown in Table 1 below to be dissolved in the aqueous ethanol solution. Then, K-Carrageenan (available from Korea Carragheen Co., Ltd, HG404) as a gelation agent and potassium chloride as a gelation aid were added at ratios shown in Table 1 below to obtain an aqueous composition for preparing a film.

TABLE 1

| | | | | | | Temperature |
|---|---|---|---|---|---|---|
| | | | | K- | Potassium | of aqueous |
| | water | ethanol | HPMC | Carrageenan | chloride | ethanol |
| | (parts by | (parts by | (parts by | (parts by | (parts by | solution |
| | weight*1) | weight*1) | weight*1) | weight*2) | weight*2) | (° C.) |
| Example 1 | 65 | 15 | 20 | 1.5 | 0 | 60 |
| Example 2 | 65 | 15 | 20 | 1.0 | 0.05 | 60 |
| Example 3 | 65 | 15 | 20 | 0.7 | 0.2 | 60 |
| Example 4 | 65 | 15 | 20 | 0.5 | 0.3 | 60 |
| Comparative | 80 | 0 | 20 | 1.0 | 0.5 | 60 |
| Example 1 | | | | | | |
| Comparative | 80 | 0 | 20 | 0.5 | 0.3 | 60 |
| Example 2 | | | | | | |

*1Based on 100 parts by weight of (water + ethanol + HPMC)
*2 Based on 100 parts by weight of HPMC

(Preparation of Flat Film)

Each aqueous composition for preparing a film maintained at a temperature of 60° C. was coated on a glass substrate by using a film caster (self-manufactured by Samsung Fine Chemicals Co., Ltd). Then, the glass substrate coated with the aqueous composition for preparing a film was dried at room temperature (25° C.) for 24 hours to obtain a flat film having a thickness of 100 μm.

(Preparation of Hard Capsule)

A room temperature (25° C.) metal mold pin (size 0) was immersed in each aqueous composition for preparing a film (a temperature of the composition: 60° C.) to coat each aqueous composition for preparing a film on the mold pin. Then, the mold pin was taken out from each aqueous composition for preparing a film and then dried at a temperature of 30° C. for 45 minutes to prepare a hard capsule. However, the aqueous composition for preparing a film prepared in Comparative Example 2 did not have sufficient gellability and thus, a hard capsule could not be formed.

### Evaluation Example

Gel strength of the aqueous compositions for preparing a film prepared in Examples 1 to 4 and Comparative Examples 1 and 2, tensile strength and hardness of the flat films prepared in Examples 1 to 4, and Comparative Examples 1 and 2, haze of the hard capsules (hence, capsule films) prepared in Examples 1 to 4, and Comparative Example 1 were measured by using the following method, and the results are shown in Table 2 below:

(Evaluation Method of Gel Strength of Aqueous Composition for Preparing a Film)

Each aqueous composition for preparing a film maintained at a temperature of 60° C. was cooled to room temperature (about 25 ° C.) and then gelled. Then, a Texture Analyser (Brookfield, CT3-4500, Probe No: TA10) was used to measure the strength of a gel formed from each aqueous composition for preparing a film. However, the aqueous compositions for preparing a film prepared in Comparative Examples 1 and 2 did not have sufficient gellability to form a gel and thus, the gel strength could not be measured.

(Evaluation Method of Tensile Strength and Hardness of Flat Film)

Each of the flat films was cut into a size of 1 cm×10 cm and then a LLOYD Instrument testing machine (LRX plus, available from LLOYD Instruments, UK) was used to measure tensile strength of the flat film. Also, each of the flat films was cut into a size of 4 cm×5 cm and then a Texture Analyzer (Brookfield, CT3-4500, Probe No. TA-39) was used to measure hardness of the flat film.

(Evaluation Method of Haze of Hard Capsule)

The hard capsules prepared in Examples 1 to 4 and Comparative Example 1 were each put into a 40 mL vial bottle and then maintained at a temperature of 40° C., under 75% RH (relative humidity) condition for 4 weeks. Then, light having a wavelength of 420 nm was irradiated by using a UV spectrophotometer (JASCO, V-550) to each hard capsule to measure light transmittance. Here, the higher the light transmittance, the lower the haze.

TABLE 2

| | | | | Properties |
|---|---|---|---|---|
| | Gel strength of | | | of a hard |
| | aqueous | Properties of a flat film | | capsule |
| | composition for | Tensile | | Light |
| | preparing a film | strength | | transmittance |
| | (g) | (N/mm2) | Hardness (g) | (%) |
| Example 1 | 120 | 66 | 3,250 | 96 |
| Example 2 | 118 | 64 | 3,190 | 94 |
| Example 3 | 115 | 60 | 3,205 | 92 |
| Example 4 | 116 | 60 | 3,120 | 91 |
| Comparative | Not measurable | 52 | 2,640 | 51 |
| Example 1 | | | | |
| Comparative | Not measurable | 52 | 2,570 | Not |
| Example 2 | | | | measurable |

Referring to Table 2 above, the flat films prepared in Examples 1 to 4 showed higher tensile strength and hardness than the flat films prepared in Comparative Examples 1 and 2. Also, the hard capsules prepared in Examples 1 to 4 showed higher light transmittance than the hard capsule prepared in Comparative Example 1.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A film comprising:
a water-soluble cellulose ether;
about 0.5 parts by weight to about 1.5 parts by weight of a gelation agent based on 100 parts by weight of the water-soluble cellulose ether; and
0 parts by weight to about 0.3 parts by weight of a gelation aid based on 100 parts by weight of the water-soluble cellulose ether, wherein
light transmittance is 80% or greater.

2. The film of claim 1, wherein the water-soluble cellulose ether comprises hydroxypropyl methylcellulose (HPMC), hydroxyethyl methylcellulose (HEMC), methylcellulose (MC), or a mixture of two or more of these.

3. The film of claim 1, wherein the gelation agent comprises Carrageenan, Gellan gum, Xanthan gum, Pectin, or a mixture of two or more of these.

4. The film of claim 1, wherein the gelation aid comprises potassium chloride, potassium acetate, calcium chloride, or a mixture of two or more of these.

5. The film of claim 1, further comprising 0 parts by weight to about 5.0 parts by weight of other additives based on 100 parts by weight of the water-soluble cellulose ether.

6. The film of claim 5, wherein the other additives comprise a plasticizer, an emulsifier, or a mixture of two or more of these.

7. The film of claim 1,
wherein the film is a hard capsule, a flat film, a film for food, a medicinal film, or an industrial film.

8. The film of claim 2, wherein the film is a hard capsule, a flat film, a film for food, a medicinal film, or an industrial film.

9. The film of claim 3, wherein the film is a hard capsule, a flat film, a film for food, a medicinal film, or an industrial film.

10. The film of claim 4, wherein the film is a hard capsule, a flat film, a film for food, a medicinal film, or an industrial film.

11. The film of claim 5, wherein the film is a hard capsule, a flat film, a film for food, a medicinal film, or an industrial film.

12. The film of claim 6, wherein the film is a hard capsule, a flat film, a film for food, a medicinal film, or an industrial film.
